(19) United States
(12) Patent Application Publication
(10) Pub. No.: US 2026/0159194 A1
(43) Pub. Date: Jun. 11, 2026

(54) Method for Operating a Pedal-Driven Vehicle

(71) Applicant: Robert Bosch GmbH, Stuttgart (DE)

(72) Inventors: Daniel Gronbach, Stuttgart (DE); Joseph Reck, Weil Im Schoenbuch (DE); Juergen Stegmaier, Wannweil (DE); Marcus Boege, Rottenburg Am Neckar (DE); Matthias Weinmann, Balingen (DE)

(21) Appl. No.: 19/411,219

(22) Filed: Dec. 6, 2025

(30) Foreign Application Priority Data
Dec. 11, 2024 (DE) 10 2024 211 804.4

(51) Int. Cl. B62M 6/50

(52) U.S. Cl. CPC B62M 6/50

(57) ABSTRACT

A method for operating a pedal-driven vehicle, a pedal-driven vehicle, a computer program product, a computer-readable data carrier, and a data carrier signal are disclosed. The method includes ascertaining a first speed which is specific to the pedal-driven vehicle. The method further includes ascertaining a second speed or a third speed which is specific to the pedal-driven vehicle. The method also includes calculating, by a control unit, a final speed as a function of the first speed and (i) the second speed, or (ii) the third speed. In addition, the method includes operating, by the control unit, the pedal-driven vehicle as a function of the final speed.

This application claims priority under 35 U.S.C. § 119 to patent application no. DE 10 2024 211 804.4, filed on Dec. 11, 2024 in Germany, the disclosure of which is incorporated herein by reference in its entirety.

The disclosure relates to a method for operating a pedal-driven vehicle, a pedal-driven vehicle, a computer program product, a computer-readable data carrier, and a data carrier signal.

### BACKGROUND

Pedal-driven vehicles are known, in particular, (electric) bicycles (“e-bikes”) or pedelecs, which have a control unit and/or (automatic and/or electric) gearshift and/or at least one rider assistance function (for example, an ABS) and/or a drive unit (for example, a motor). In addition, at least a first speed may be measured, which is specific to an (actual) speed of the pedal-driven vehicle. For example, this may take place, in particular, via a sensor, which has a permanent magnet, for example, on a spoke of a wheel of the pedal-driven vehicle, and a corresponding detection unit, for example, a Hall sensor and/or a reed sensor (for example, on the frame of the pedal-driven vehicle). When the permanent magnet passes the detection unit, a current and/or a voltage may be induced. As a function of the measurement signal, a (first/actual) speed may be calculated, for example, by way of a control unit, in particular, as a function of the time interval between two induction pulses and the (known and/or stored) wheel circumference.

The prior art has disadvantages in this respect. Thus it may be that the measuring and/or determining of the speed is not possible and/or is inaccurate. For example, the permanent magnet and/or the detection unit may change its position. This may lead to a failure and/or distortion of the measurement. It may be that no (intrinsic) validation of the ascertained results is provided. There may be an (excessively) high latency. For example, at slow (actual) speeds, in particular, a large time interval between induction pulses may be present (for example, 3 seconds). This may make the measurement of the speed inaccurate. In addition, the (temporal) resolution may be low.

### SUMMARY

According to the disclosure, the following is provided: a method, a pedal-driven vehicle, a computer program product, a computer-readable data carrier, and a data carrier signal having the features set forth below. Further features and details of the disclosure will become apparent from the description and the drawings. Features and details that are described in connection with the method of the disclosure naturally also apply in connection with the pedal-driven vehicle of the disclosure and/or in connection with the computer program product of the disclosure, and/or in connection with the computer-readable data carrier of the disclosure, and/or in connection with the data carrier signal of the disclosure, and vice versa in each case, such that, with respect to the disclosure of the individual aspects of the disclosure, mutual reference is or may be made in each case. In particular, advantages which are described in the context of the first, second, third, fourth and/or fifth aspect in each case also apply to the first, second, third, fourth and/or fifth aspect.

According to a first aspect, the present disclosure relates to a method for operating a pedal-driven vehicle, in particular, a bicycle, comprising a control unit, the method comprising
ascertaining a first speed which is specific to the pedal-driven vehicle,
ascertaining a second speed and/or a third speed which is specific to the pedal-driven vehicle,
calculating, by the control unit, a final speed as a function of the first speed, and
   the second speed, and/or
   the third speed,
operating, by the control unit, the pedal-driven vehicle as a function of the final speed.

The method may in this case be (at least partially) computer-implemented. In particular, operating may comprise controlling and/or regulating, wherein a control unit (see below) is preferably used, which, in particular, controls and/or regulates the (automatic and/or electric) gearshift and/or at least one rider assistance function (for example, an ABS) and/or a drive unit (for example, a motor) (for example, by actuating signals). The described actions or features of the method may be carried out in the sequence shown and, in particular, may be carried out repeatedly. Preferably, the method may be carried out (continuously) during and/or while operating and/or using a pedal-driven vehicle and/or a corresponding control unit and/or gearshift. Preferably, the method may be used to operate a pedal-driven vehicle according to the second aspect, in particular, to control and/or regulate it. More preferably, a control unit configured for this purpose may be used for operating, in particular, for actuating and/or controlling and/or regulating. The control unit may in this case carry out the corresponding actions or features and/or carry out actuation (for example, via actuating signals) in order preferably to implement the actions. For example, actuators (for example, of the gearshift) which are in data communication with the control unit via a data connection may be actuated by the control unit (in the context of the operating). For example, as a result, an automatic gear change of the gearshift may be implemented (for example, as a function of the final speed).

The method may be configured to provide, in particular, continuously and/or at short time intervals (for example, of 100 ms) a final speed. In other words, a final speed may be calculated as a function of the first, second and/or third speed. As a result, an increased accuracy and/or robustness may be achieved. Accordingly, improved operation may be enabled. As a result, safety, comfort, and/or wear may be optimized.

The ascertaining of a first speed which is specific to the pedal-driven vehicle and the ascertaining of a second speed and/or a third speed which is specific to the pedal-driven vehicle may (in each case) be carried out (measured) by at least one (respective) sensor (see below). Preferably, the different sensors may use different (physical) measurement principles. As a result, the robustness, reliability, and/or accuracy may be improved. It may be provided that the first, second, and/or third speed have, in respective first, second, and/or third speed ranges, a different accuracy, robustness, and/or reliability. Accordingly, the control unit may provide more accurate calculation as a function of a first, second, third speed and/or final speed.

The first, second, and/or third speed may be ascertained differently and/or separately and/or (temporally) in parallel and/or continuously. This may provide redundancy, which in particular increases robustness and/or reliability and/or comfort, in particular, because the rider can view a current and/or actual speed (at all times and/or reliably), for example, via a display device (for example, a speedometer) connected to the control unit.

In this case, the first, second, and/or third speed may (in each case) be specific to an actual and/or current actual speed of the pedal-driven vehicle. For example, the actual and/or current actual speed may be 5 km/h. For example, the first speed may be 4 km/h. For example, the second speed may be 4.5 km/h. For example, the third speed may be 5.1 km/h.

The calculating, by the control unit, of a final speed as a function of the first speed and
the second speed, and/or
the third speed, may be carried out in the simplest case by selecting one of the first, second, and/or third speeds, preferably, the (probably) most precise and/or most reliable, and/or that which most closely corresponds to the actual speed, and outputting it as the final speed. For example, this may be carried out as a function of a first, second, and/or third reliability range.

Alternatively or additionally, it may be provided that the calculating provides as final speed a (weighted) average value as a function of the first, second, and/or third speed.

The operating, by the control unit, of the pedal-driven vehicle as a function of the final speed may comprise controlling and/or regulating the pedal-driven vehicle, in particular, a gearshift, a functionally essential component, a rider assistance function (for example, ABS), and/or a navigation system.

Within the scope of the disclosure, it may be advantageous if the first speed is ascertained as a function of a wheel rotational speed, in particular, a reed signal and/or Hall signal, which is generated, for example, by a reed switch and/or a Hall sensor.

For example, a first sensor may be provided on the pedal-driven vehicle, which is configured for measuring the first speed and/or a first reed signal and/or measurement signal, as a function of which the control unit may ascertain the first speed. For example, this may take place, in particular, via a sensor, which has a permanent magnet, for example, on a spoke of a wheel of the pedal-driven vehicle, and a corresponding detection unit, for example, a Hall sensor and/or a reed sensor and/or reed switch (for example, on the frame of the pedal-driven vehicle). When the permanent magnet passes the detection unit, a current and/or a voltage may be induced. As a function of the measurement signal, a (first/actual) speed may be calculated, for example, by way of a control unit, in particular, as a function of the time interval between two induction pulses and the (known and/or stored) wheel circumference.

Within the scope of the disclosure, it is contemplated that the second speed may be ascertained as a function of a torque signal, in particular, of a torque sensor, and
a pedaling cadence of a rider, which is measured, in particular, on a crank of the pedal-driven vehicle, and/or
a motor frequency, in particular, of a motor of the pedal-driven vehicle.

A (second) sensor may be provided, for example a torque sensor, which is arranged, in particular, on a crank of the pedal-driven vehicle and/or is configured to ascertain a torque of the rider and/or of the motor. In this case, a torque signal may be provided which may, for example, have a periodic and/or sinusoidal profile. Based thereupon, the control unit may ascertain a pedaling cadence and/or motor frequency, for example, by fitting and/or peak detection. The (second) sensor, in particular, the torque sensor, and/or the control unit may be configured to detect when the rider is pedaling (if at all). In particular, the (second) sensor, the torque sensor, and/or the control unit may be configured to detect a torque provision of the motor and/or of the rider (if at all). The control unit may, as a function of the pedaling cadence and/or motor frequency and a transmission ratio (of the gearshift and/or with the [rear] wheel) and/or the motor transmission, ascertain the second speed, in particular, by ascertaining a wheel revolution time and/or rotational frequency of the (rear) wheel and, in particular, as a function of a (known) wheel circumference, the second speed. By way of the second speed, redundancy may already be provided. As a result, the accuracy and/or robustness and/or reliability may be increased. Alternatively or additionally, the second speed, in particular, the pedaling cadence of the rider, may be ascertained as a function of a motor rotational speed, which may preferably be measured by a rotational-speed sensor and/or a (dedicated) cadence sensor and/or when an engagement is present between crank and motor.

It may be provided that the first speed is set to zero if no pedaling cadence and/or motor frequency is ascertained/may be ascertained.

It may be provided within the scope of the disclosure that the third speed is calculated as a function of an acceleration signal, wherein an acceleration signal is measured, in particular, by an acceleration sensor of the pedal-driven vehicle.

The (third) sensor may be configured as an acceleration sensor. For example, the acceleration sensor may be arranged on and/or in the frame and/or in the control unit. The acceleration sensor may be configured to measure an acceleration of the pedal-driven vehicle, in particular along and/or against the direction of travel, and/or to provide an acceleration signal, in particular to the control unit. The control unit may ascertain a, in particular, relative, third speed. Accordingly, the third speed may be calculated as a function of a reference value (a reference speed) and a relative change in speed. For example, the (measured) acceleration or the acceleration signal may be integrated over time and/or over a time interval in order to obtain a third speed and/or relative change in speed.

Furthermore, it is contemplated that the third speed may be ascertained as a function of a reference value, in particular, a (past) first speed, a (past) second speed, and/or a (past) third speed and/or a relative change in speed, which is preferably ascertained as a function of an acceleration.

The relative change in speed may be obtained by (up-)integrating the acceleration signal. The reference value may correspond to a (past) first speed, a (past) second speed, a (past) third speed, and/or a past final speed, preferably from an earlier and/or the previous calculation step. The reference value may be ascertained as a function of a first, second, and/or third reliability range.

It may also be provided that the value zero is used as reference value, for example, when starting from a traffic light and/or when the pedal-driven vehicle is previously stationary.

It is also conceivable that the calculating may comprise combining, in particular, weighting, the first speed and
the second speed, and/or
the third speed, in order to obtain the final speed.

The combining may comprise calculating an average value (equal weighting of first, second, and/or third speed).

The weighting may comprise a specific and/or respective weighting of the first, second, and/or third speed, for example, by way of a first, second, and/or third reliability range and/or weighting factor, which may, in particular, be preset (during commissioning and/or manufacture) and/or stored in the control unit, for example, in a (lookup) table. Accordingly, as a function of a (past) first, second, and/or third speed and/or final speed, a first, second, and/or third reliability range and/or weighting factor may be ascertained. For example, the final speed may be ascertained, wherein
the first speed is multiplied by the first weighting factor (for example, 0.5),
the second speed is multiplied by the second weighting factor (for example, 0.3), and/or
the third speed is multiplied by the third weighting factor (for example, 0.2). For example, the result may subsequently be divided by three and/or a scaling factor (for example, 0.95) (in order to obtain the final result), wherein the scaling factor is, for example, (again) dependent on a (past) first, second, and/or third speed and/or final speed.

Within the scope of the disclosure, it is optionally possible that the calculating, in particular, the combining and/or weighting, takes place as a function of
a first reliability range of the first speed,
a second reliability range of the second speed, and/or
a third reliability range of the third speed, wherein, in particular,
the first reliability range is maximal for a (comparatively) high speed, in particular, a high first speed and/or greater than 15 km/h,
the second reliability range is maximal for a (comparatively) high acceleration, in particular, a strongly increasing second speed and/or greater than 0.5 m/s²,
the third reliability range is maximal for a (comparatively) high negative acceleration, in particular, a strongly falling third speed and/or less than −0.5 m/s².

The first, second, and/or third reliability range may be specific to a reliability as a function of a (first, second, and/or third) speed. In other words, the first, second, and/or third speed may, in particular, on account of the respective (physical) measurement, have in different speed ranges a specific accuracy and/or reliability. This may be used within the scope of the method in order to improve reliability, accuracy, and/or robustness.

The first, second, and/or third reliability range may have a (speed-dependent) distribution function which has, for example, (as discrete) values (for example, in intervals of 0.05 km/h from 0 to 50 km/h) a first, second, and/or third weighting factor. The first, second, and/or third reliability range may have, for a (each) specific first speed, second speed, third speed, and/or final speed, a value between 0 and 1, which may, in particular, be used for weighting. Preferably, it may be provided that, for a (each) value of the first speed, second speed, third speed, and/or final speed, the first, second, and/or third reliability range, in particular, when summing the respective values or weighting factors, results in the value 1 in total. This makes it possible to carry out speed-dependent weighting.

In the context of commissioning, it may be ascertained on the basis of simulations and/or empirically at which (past and/or last ascertained) first, second, third speed and/or final speed the most accurate result for calculating a final speed is made possible. As a result, the first, second, and/or third reliability range may be provided.

The first, second and/or third reliability range may be stored in the control unit, for example, in the commissioning and/or assembly and/or maintenance, for example, in the form of a (lookup) table.

Furthermore, it may be provided within the scope of the disclosure that the calculating, in particular, the combining, takes place by weighting, wherein
the first reliability range is weighted with, in particular, multiplied by, the first speed,
the second reliability range is weighted with, in particular, multiplied by, the second speed, and/or
the third reliability range is weighted with, in particular, multiplied by, the third speed.

In this case, on the basis of the first reliability range, a (current) first weighting factor and/or value may be ascertained as a function of the (past and/or current) first, second, third speed and/or final speed, which is, in particular, subsequently multiplied by the first speed.

On the basis of the second reliability range, a (current) second weighting factor and/or value may be ascertained as a function of the (past and/or current) first, second, third speed and/or final speed, which is, in particular, subsequently multiplied by the second speed.

On the basis of the third reliability range, a (current) third weighting factor and/or value may be ascertained as a function of the (past and/or current) first, second, third speed and/or final speed, which is, in particular, subsequently multiplied by the third speed.

The first, second, and/or third reliability range may preferably have a continuous and/or differentiable profile. As a result, in particular, in the transition regions, in which, in particular, a different speed is used for the final speed, a smoother transition and/or a blending between the first, second, and/or third speed may be achieved.

Subsequently, summing and/or averaging and/or dividing, in particular, by three and/or a scaling factor, may be carried out in order, preferably, to ascertain the final speed. In other words, this makes it possible to achieve a blending between different speed values. As a result, the accuracy and/or robustness may be improved.

It may be provided that the first, second and/or third speed is (only) used if it has been validated by the (and/or a past) first, second and/or third speed, for example, (validation may be positive) if a percentage deviation is undershot (for example, is less than 10%).

In relation to the present disclosure, it is conceivable that, in the calculating, in particular, the combining, the final speed (and/or an intermediate result) may be ascertained as a function of the first speed and the third speed, wherein the final speed (and/or the intermediate result)
corresponds to the first speed if the latter is less than or equal to the third speed, or
corresponds to the third speed if the latter is less than or equal to the first speed.

In particular, this may be advantageous because in negative acceleration (deceleration) and/or starting from (comparatively) high speeds (for example, 30 km/h), the third speed may have a (comparatively) high accuracy, in particular, in comparison with the first and/or second speed. Accordingly, it may be provided to use (always) the third speed if it is lower than the first and/or second speed. During deceleration, the second speed may be zero (no pedaling).

Additionally or alternatively, it is conceivable that, in the calculating, in particular, the combining, the final speed (in particular, as a function of the intermediate speed) may correspond
to the first speed, or, in particular, the third speed (or the intermediate result) if it is greater than or equal to the second speed, or
to the second speed if it is greater than or equal to the first speed, or, in particular, the third speed (or the intermediate result).

This may be advantageous because, in particular, during acceleration and/or starting from (comparatively) low speeds (for example, 0 km/h), the second speed may have a (comparatively) high accuracy, in particular, in comparison with the first and/or third speed. Accordingly, it may be provided to use (always) the first speed if it is greater than the second and/or third speed and/or at high (first, second, and/or third) speeds.

Within the scope of the disclosure, it may be advantageous if, in the calculating, in particular, the combining, the final speed is ascertained as a function of a feedback speed, wherein the feedback speed, in particular, comprises a past final speed.

In this case, the feedback speed may have been calculated in a previous and/or earlier calculation and, in particular, may have a (past) final speed. The feedback speed may in this case be used for validating (see above).

According to a second aspect, a pedal-driven vehicle of the disclosure is provided, comprising at least one control unit, wherein the pedal-driven vehicle is configured to be operated according to a (by a) method under the first aspect.

The pedal-driven vehicle and/or the (electric and/or automatic) gearshift may be operated by a control unit (of the pedal-driven vehicle). The control unit may have a memory and/or a computing unit, in particular, a computer and/or other data processing device. The control unit may be connected via a (respective) data connection and/or be in data communication with at least one sensor, for example, for example, an acceleration sensor, a pedaling cadence sensor, and/or a reed sensor, which may, for example, be arranged on the crank and/or on the frame and/or on a pedal. The control unit may be connected to the gearshift via a (respective) data connection and/or be in data communication with the gearshift and may, in particular, operate it (actuate and/or regulate it) by actuator signals, for example, by way of corresponding actuators of the gearshift, for example, on a derailleur of the gearshift. The control unit may be connected to a functionally essential component and/or to a driver assistance function (for example, ABS) via a (respective) data connection, and/or be in data communication with it, and may, in particular, operate it (actuate and/or regulate it) by actuator signals, for example, by way of corresponding actuators of the functionally essential component, for example, on an ABS (anti-lock braking system).

Accordingly, the same advantages arise with respect to a pedal-driven vehicle of the disclosure in accordance with the second aspect as have already been described with respect to a method of the disclosure in accordance with the first aspect.

According to a third aspect, a computer program product of the disclosure is provided, comprising instructions which cause a pedal-driven vehicle in accordance with the second aspect to execute a method in accordance with the first aspect.

This results, for a computer program product of the disclosure according to the third aspect, in the same advantages as those already described with respect to a method of the disclosure according to the first aspect, and/or a pedal-driven vehicle of the disclosure according to the second aspect.

According to a fourth aspect, a computer-readable data carrier of the disclosure is provided, on which a computer program product according to the third aspect is stored.

This results, for a computer-readable data carrier of the disclosure according to the fourth aspect, in the same advantages as those already described with respect to a method of the disclosure according to the first aspect and/or a pedal-driven vehicle of the disclosure according to the second aspect and/or a computer program product of the disclosure according to the third aspect.

According to a fifth aspect, a data carrier signal of the disclosure is provided, which transmits a computer program product according to the fourth aspect.

Accordingly, the same advantages arise with respect to a data carrier signal of the disclosure in accordance with the fifth aspect as have already been described with respect to a method of the disclosure in accordance with the first aspect and/or a pedal-driven vehicle of the disclosure in accordance with the second aspect, and/or a computer program product of the disclosure in accordance with the third aspect, and/or a computer-readable data carrier of the disclosure in accordance with the fourth aspect.

### BRIEF DESCRIPTION OF THE DRAWINGS

Further advantages, features and particulars of the disclosure will become apparent from the following description, in which several exemplary embodiments of the disclosure are described in detail with reference to the drawings. The features mentioned in the claims and in the description may each be essential to the disclosure individually or in any desired combination. It is schematically illustrated by way of example:

FIG. 1 a method, and

FIG. 2 a pedal-driven vehicle.

In the figures, identical reference signs are used for the same technical features, including

across different exemplary embodiments.

### DETAILED DESCRIPTION

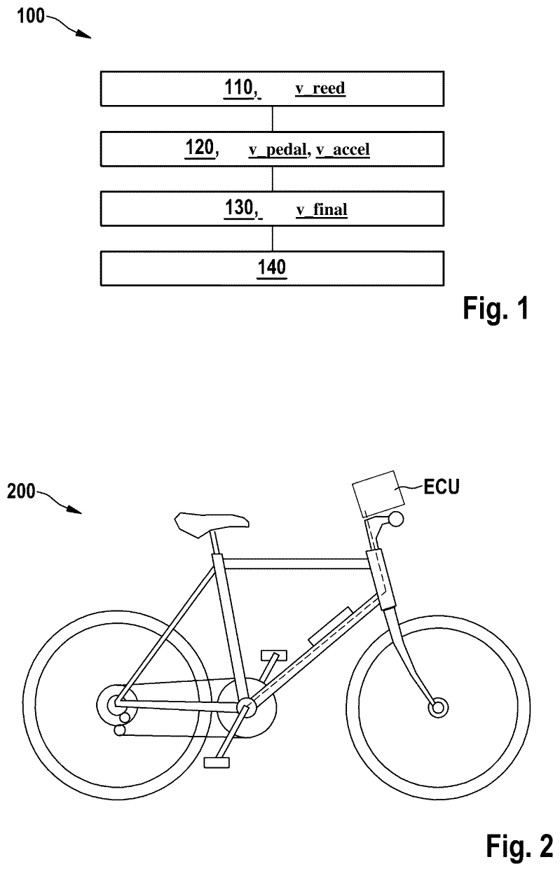

FIG. 1 shows a method 100 for operating 140 a pedal-driven vehicle 200, in particular, a bicycle, comprising a control unit ECU, the method 100 comprising
ascertaining 110 a first speed v_reed which is specific to the pedal-driven vehicle 200,
ascertaining 120 a second speed v_pedal or a third speed v_accel which is specific to the pedal-driven vehicle 200,
calculating 130, by the control unit ECU, a final speed v_final as a function of the first speed v_reed and
   the second speed v_pedal, or
   the third speed v_accel,
operating 140, by the control unit ECU, the pedal-driven vehicle 200 as a function of the final speed v_final.

Within the scope of the disclosure, it may be advantageous if the first speed v_reed is ascertained as a function of a wheel rotational speed, in particular, a reed signal, which is generated, for example, by a reed switch.

Within the scope of the disclosure, it is conceivable that the second speed v_pedal may be ascertained as a function of a torque signal, in particular, of a torque sensor, and
a pedaling cadence of a rider, which is measured, in particular, on a crank of the pedal-driven vehicle, and/or
a motor frequency, in particular, of a motor of the pedal-driven vehicle.

It may be provided within the scope of the disclosure that the third speed v_accel is calculated as a function of an acceleration signal, wherein the acceleration signal is measured, in particular, by an acceleration sensor of the pedal-driven vehicle 200.

Furthermore, it is conceivable that the third speed v_accel may be ascertained as a function of a reference value, in particular, a first speed v_reed, a second speed v_pedal, and/or a past third speed, and as a function of a relative speed change, which is preferably ascertained as a function of an acceleration.

It is also conceivable that the calculating 130 may comprise combining, in particular, weighting, the first speed v_reed and
the second speed v_pedal, and/or
the third speed v_accel,
   in order to obtain the final speed v_final.

Within the scope of the disclosure, it is optionally possible that the calculating 130, in particular, the combining, takes place as a function of
a first reliability range of the first speed v_reed,
a second reliability range of the second speed v_pedal, and/or
a third reliability range of the third speed v_accel,
   wherein, in particular,
the first reliability range is maximal for a high speed, in particular, a high first speed v_reed and/or greater than 15 km/h,
the second reliability range is maximal for a high acceleration, in particular, a strongly increasing second speed v_pedal and/or greater than 0.5 m/s²,
the third reliability range is maximal for a high negative acceleration, in particular, a strongly falling third speed v_accel and/or less than −0.5 m/s².

Furthermore, it may be provided within the scope of the disclosure that the calculating 130, in particular, the combining, takes place by weighting, wherein
the first reliability range is weighted with, in particular, multiplied by, the first speed v_reed,
the second reliability range is weighted with, in particular, multiplied by, the second speed v_pedal, and/or
the third reliability range is weighted with, in particular, multiplied by, the third speed v_accel.

In relation to the present disclosure, it is conceivable that, in the calculating 130, in particular, the combining, the final speed v_final is ascertained as a function of the first speed v_reed and the third speed v_accel, wherein the final speed v_final
corresponds to the first speed v_reed if the latter is less than or equal to the third speed v_accel, or
corresponds to the third speed v_accel if the latter is less than or equal to the first speed v_reed.

Furthermore, it is conceivable that, in the calculating 130, in particular, the combining, the final speed v_final may correspond:
to the first speed v_reed, or, in particular, the third speed v_accel, if it is greater than or equal to the second speed v_pedal, or
to the second speed v_pedal if it is greater than or equal to the first speed v_reed, or, in particular, the third speed v_accel.

In the context of the disclosure, it may be advantageous that, in the calculating 130, in particular, in the combining, the final speed v_final is ascertained as a function of a feedback speed, wherein the feedback speed, in particular, comprises a past final speed v_final.

FIG. 2 schematically illustrates, by way of example, a pedal-driven vehicle 200 comprising at least one control unit ECU, wherein the pedal-driven vehicle 200 is configured to be operated in accordance with a method 100 (see FIG. 1 and/or the first aspect). The control unit ECU may be in data communication via a (diagrammatically dashed) data connection with at least one (not further illustrated) sensor, for example, an acceleration sensor, a pedaling cadence sensor, and/or a reed sensor, and/or Hall sensor, which may, for example, be arranged on the crank and/or on the frame and/or on a pedal. The control unit ECU may be configured for an operating 140 of the pedal-driven vehicle 200, for example, by controlling and/or regulating an actuator (by providing an actuating signal via a data connection), in particular, a gearshift and/or a rider assistance function (for example, ABS).

What is claimed is:

1. A method for operating a pedal-driven vehicle having a control unit, the method comprising:
ascertaining a first speed which is specific to the pedal-driven vehicle;
ascertaining a second speed or a third speed which is specific to the pedal-driven vehicle;
calculating, by the control unit, a final speed as a function of the first speed and
the second speed, or
the third speed; and
operating, by the control unit, the pedal-driven vehicle as a function of the final speed.

2. The method according to claim 1, wherein the first speed is ascertained as a function of a wheel rotational speed.

3. The method according to claim 1, wherein:
the second speed is ascertained as a function of a torque signal of a torque sensor, and
a pedaling cadence of a rider which is measured on a crank of the pedal-driven vehicle, and/or
a motor frequency of a motor of the pedal-driven vehicle.

4. The method according to claim 1, wherein:
the third speed is calculated as a function of an acceleration signal, and
the acceleration signal is measured by an acceleration sensor of the pedal-driven vehicle.

5. The method according to claim 1, wherein the third speed is ascertained as a function of a reference value.

6. The method according to claim 1, wherein:
the calculating step comprises a combining of the first speed and
the second speed, and/or
the third speed,
in order to obtain the final speed.

7. The method according to claim 6, wherein the calculating step takes place as a function of:
a first reliability range of the first speed,
a second reliability range of the second speed, and/or
a third reliability range of the third speed.

8. The method according to claim 7, wherein the calculating step is achieved by a weighting, wherein:
the first reliability range is multiplied by the first speed,
the second reliability range is multiplied by the second speed, and/or
the third reliability range is multiplied by the third speed.

9. The method according to claim 1, wherein in the calculating step, the final speed is ascertained as a function of the first speed and the third speed, and wherein the final speed:
corresponds to the first speed if the latter is less than or equal to the third speed, or
corresponds to the third speed if the latter is less than or equal to the first speed.

10. The method according to claim 1, wherein in the calculating step, the final speed corresponds to:
the first speed or, the third speed, if it is greater than or equal to the second speed, or
the second speed if it is greater than or equal to the first speed or, to the third speed.

11. The method according to claim 1, wherein:
in the calculating step, the final speed is ascertained as a function of a feedback speed, and
the feedback speed comprises a past final speed.

12. A pedal-driven vehicle comprising at least one control unit, wherein the pedal-driven vehicle is configured to be operated according to the method of claim 1.

13. A computer program product comprising instructions which cause a pedal-driven vehicle to execute the method according to claim 1.

14. A computer-readable data carrier on which the computer program product according to claim 13 is stored.

15. A data carrier signal that transmits the computer program product according to claim 13.

16. The method according to claim 1, wherein the pedal-driven vehicle is a bicycle.

17. The method according to claim 1, wherein the first speed is ascertained as a function of a reed signal which is generated by a reed switch.

18. The method according to claim 1, wherein:
the third speed is ascertained as a function of a first speed, a second speed, and/or a past third speed and a relative change in speed, which is ascertained as a function of an acceleration.

19. The method according to claim 7, wherein:
the first reliability range is maximal for a high first speed and/or greater than 15 km/h,
the second reliability range is maximal for a strongly increasing second speed and/or greater than 0.5 m/s², and
the third reliability range is maximal for a strongly falling third speed and/or less than −0.5 m/s².

20. The method according to claim 1, wherein:
the calculating step comprises a weighting of the first speed and
the second speed, and/or
the third speed,
in order to obtain the final speed.
